(19) United States
(12) Patent Application Publication
(10) Pub. No.: US 2002/0163930 A1
(43) Pub. Date: Nov. 7, 2002

(54) Methods and systems for interleaving data from multi-rate channels into a single interface

(76) Inventors: Phillip Kreider, Raleigh, NC (US); Jeffrey P. Jones, Raleigh, NC (US); Hieu Pham, Cary, NC (US)

Correspondence Address: Michael T. Konczal, Godwin Gruber, P.C., Suite 655, 801 E. Campbell Rd., Richardson, TX, 75081, US

(21) Appl. No.: 10/007,293

(22) Filed: Nov. 10, 2001

Related U.S. Application Data
(60) Provisional application No. 60/272,077, filed on Feb. 28, 2001.

(51) Int. Cl. H04L 12/42

(52) U.S. Cl. 370/449; 370/459

(57) ABSTRACT

Disclosed are systems and methods for interleaving data in a multi-channel multi-rate telecommunications network. The invention provides for identifying channels having data in readiness for transmission and systematically polling such channels. The invention provides interleaving management which permits the changing of data rates and activation or deactivation of channels without major disruptions. The polling order of active channels is determined according to a state machine providing at least one state for each data rate supported by the plurality of channels.

This application claims the benefit of U.S. Provisional Application No. 60/272,077 filed Feb. 28, 2001.

### TECHNICAL FIELD

The invention relates in general to the interleaving of data in a data communications network. More particularly, the invention relates to methods and a related system for managing the interleaving of data from multiple communications channels supporting different data rates unto a single interface.

### BACKGROUND OF THE INVENTION

In the field of data communications and, particularly, data communication networks, there has been an intense push to increase data transfer rates in order to reduce the time required to transmit data from one point to another in the network. Since data rates for various equipment and types of communication systems are not uniform, it is frequently desirable to carry many signals of different rates through a single interface. The accommodation of different data rates unto a single interface makes necessary the interleaving of data from channels operating at different rates unto a single channel.

The interface of some network equipment requires that a given channel be polled at a rate which is proportional to the operational speed of the channel. For example, channels operating at Digital Signal Level three DS3 must be polled at least 21 times more often than an E1 channel. Likewise, an E1 channel needs to be polled at least 32 times more often than a DS0 channel. This requirement applies to all channels presenting data to the interface.

At the same time, the polling logic can get quite complicated because the operating speed of a given channel may change over time. Also, it is desirable to minimize the software overhead as well as the impact to other channels as one channel is decommissioned and later on reactivated. At the same time, it is desirable to maintain channel assignment flexibility so that any channel can be assigned to carry DS3, or E1, or DS0 data.

Problems in the art are illustrated by reference the mechanism, know as a Synchronous Payload Envelope or SPE, which serves as the data carrying vehicle. For example, in a network where all three SPEs are configured as 28 T1s, the polling memory contents would look like this: {SPE1 T1 #1; SPE2 T1 #1; SPE3 T1 #1; SPE1 T1 #2; . . . }. If the network channels were reconfigured such that SPE1 T1 #1 is now eight 2×DS0s, the memory would require substantial alteration to manage the new DS0s. The memory would then look like this: {SPE1 DS0 #1; SPE2 T1 #1; SPE3 T1 #1; SPE1 T1 #2; . . . , SPE 3 T1 #28; SPE1 DS0 #2; SPE2 T1 #1; . . . }. The reconfiguration requires significant changes to the memory contents, including expanding from 84 entries to a much larger amount with a DS0-configured T1 slot appearing every 84 entries requiring 672 entries to manage 8×84 repeats. This is difficult for software to manage and requires significant setup and tear down to reconfigure.

Therefore, the interleaving of various data rates unto a single interface necessitates that various channels present data to the interface at rates proportional to the speed at which the channel operates. Current interleaving techniques require that the data rate of each channel and the number and identity of each channel remains constant. Such systems and techniques do not allow for reconfiguration of the channels without significant software changes and potential traffic interruptions.

An additional problem with current interleaving techniques is the complexity of the algorithms. For example, in an application supporting 256 channels, the polling logic must be written to individually address each channel with the correct rate. The deactivation or reactivation of any channel, or a change in the data rate of any channel, requires a complex reprogramming effort.

Therefore, it would be desirable to provide for the systematic management of interleaving data from multiple channels supporting different data rates unto a single interface. A means of polling the channels that provides flexibility of the polling process even after channels are reconfigures would provide numerous advantages in the form of decreased down time for reconfiguration, decreased expense, and increased routing efficiency.

### SUMMARY OF THE INVENTION

The invention provides systems and methods for interleaving data in a multi-channel multi-rate telecommunications network. In general, the invention provides techniques for identifying channels having data in readiness for transmission and systematically polling such channels.

According to one aspect of the invention, a method of interleaving data into a single interface from a plurality of channels supporting a plurality of data rates is provided. The method includes steps for polling each channel in the data communications system to determine if the channels are active. The polling order is determined according to a state machine providing at least one state for each data rate supported by the plurality of channels. Steps are provided for interleaving data from active channels into a single interface according the states of the state machine.

According to another aspect of the invention, provisions are made for readily changing the data rate of a plurality of the channels.

According to yet another aspect of the invention, a reconfigurable transmit mechanism supporting the interleaving of data from data channels having dissimilar data rates is provided. The mechanism provides sequential circuit means for polling each data channel to identify active channels. The invention also includes means for interleaving data from the active data channels into a single interface for transmission.

According to still another aspect of the invention, the mechanism additionally includes means for reconfiguring one or more channels for different data rates.

The invention also provides a routing circuit for use in a data communications system supporting the interleaving of data from a plurality of data channels having dissimilar data rates. The routing circuit is configured for sequentially identifying active data channels from among a plurality of channels and inviting the active channels to send data according to a sequence of selected data rates.

According to an additional aspect of the invention, a routing circuit provides accommodations for the use of at least four dissimilar data rates.

According to yet another aspect of the invention, a routing circuit is also adapted for reconfiguring the data channels for different data rates.

The invention provides numerous technical advantages including ease of reconfiguration to accommodate changes in the mix of dissimilar data rates in a multi-channel, multi-rate environment. An additional advantage of the invention is reduced complexity in managing the interleaving of data in a communications network. Programming, memory requirements, and downtime are also reduced.

### BRIEF DESCRIPTION OF THE DRAWINGS

The above advantages, as well as specific embodiments of the present invention, will be more clearly understood from consideration of the following descriptions in connection with the accompanying drawings in which:

FIG. 1 is a block diagram depicting an example of the use of the invention to route data in a network;

FIG. 2 is a state diagram providing an illustration exemplifying an implementation of the concept of the invention; and

FIG. 3 is a process flow diagram depicting an example of a system and steps according to the invention.

Corresponding numerals and symbols in the various figures refer to corresponding parts unless otherwise indicated. Some features of embodiments shown and discussed are simplified or exaggerated for illustrating the principles of the invention.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. It should be understood that the invention may be practiced with data and networks of various types and in various configurations having different combinations of physical layers and data rates.

An example of a data communication network with an ability to accommodate a variety of transmission rates is the Synchronous Optical NETwork (SONET) standard for optical communications transport. SONET technology implements the interleaving of data of various transmission rates such as, Digital Signal level Zero (DS0) at 64 kilobytes per second, DS1 at 1.544 megabytes per second, DS2 at 6.312 megabytes per second, and DS3 at 44.736 megabytes per second.

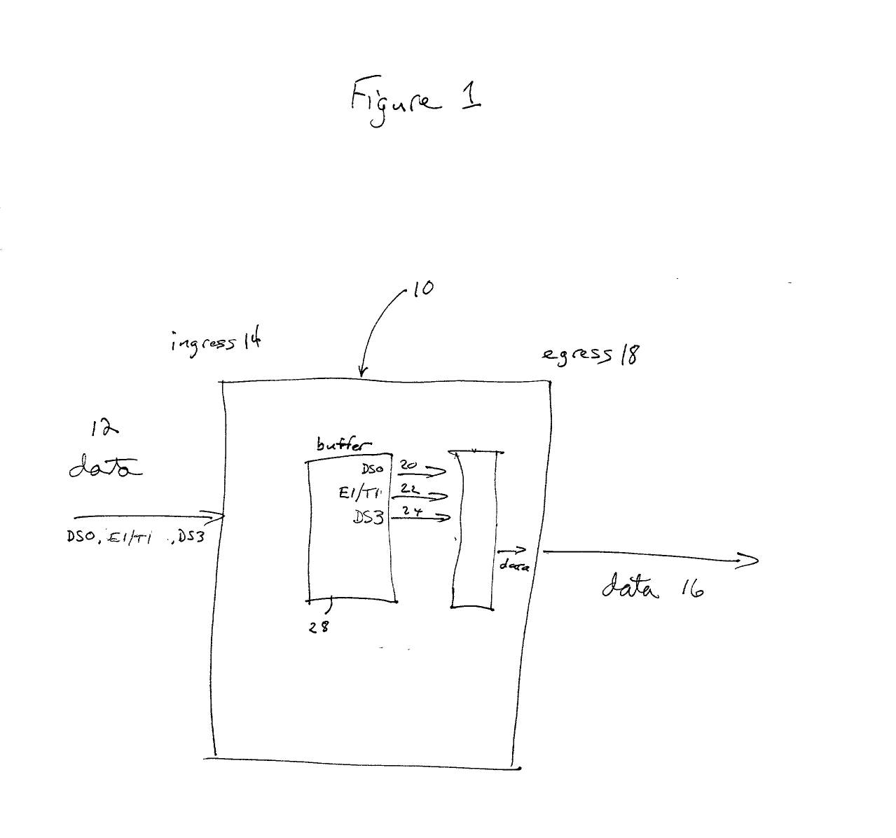

FIG. 1 is a simplified block diagram showing an example of the interleaving of data channels having differing data rates for transmission in a communications network. In general, a data interleaving management function 10 of the invention receives incoming data 12 at an ingress port 14 and transmits interleaved data 16 at an egress port 18. It will be understood that the block diagram shown and described is intended to be representative of the systems and methods of the invention and not descriptive of a particular physical structure. The incoming data 12 contains channels having data of various rates such as, for example, DS0, E1/T1, and DS3, represented by arrows 20, 22, and 24, respectively. The incoming data 12 is preferably maintained in a buffer 28 in order to facilitate the implementation of the interleaving management functions of the invention. Interleaved data 16 is then output through the egress port 18.

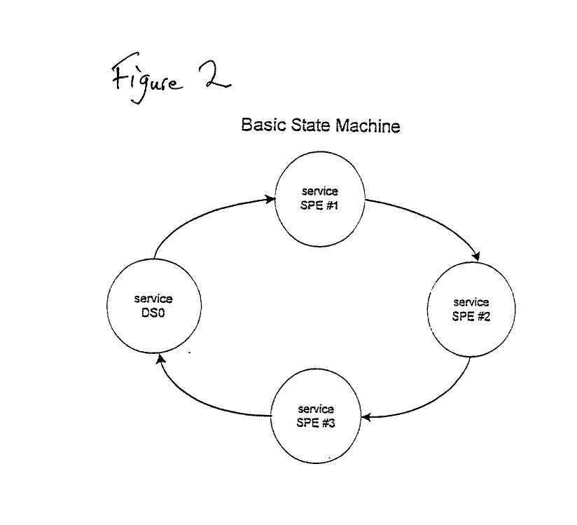

FIG. 2 is a representation of a state machine of the invention. The state machine, the implementation of which may include hardware, software, or firmware, manages the sequential polling of channels of the communications network. As can be seen in FIG. 2, the state machine proceeds from the service of SPE1 (a first Synchronous Payload Envelope), to the service of SPE2, to the service of SPE3, and to the service of DS0 in round-robin fashion, which in principle, may continue indefinitely. Thus, as the transmission of data corresponding to each state of the state machine is completed, the state machine advances to the next state and the egress port is continuously outputting data. In this way, all time slots carry data and the output line does not become “starved” for data. Although four states are shown and described in the preferred embodiment herein, the invention may be implemented with more, or less numerous, data rates and corresponding states.

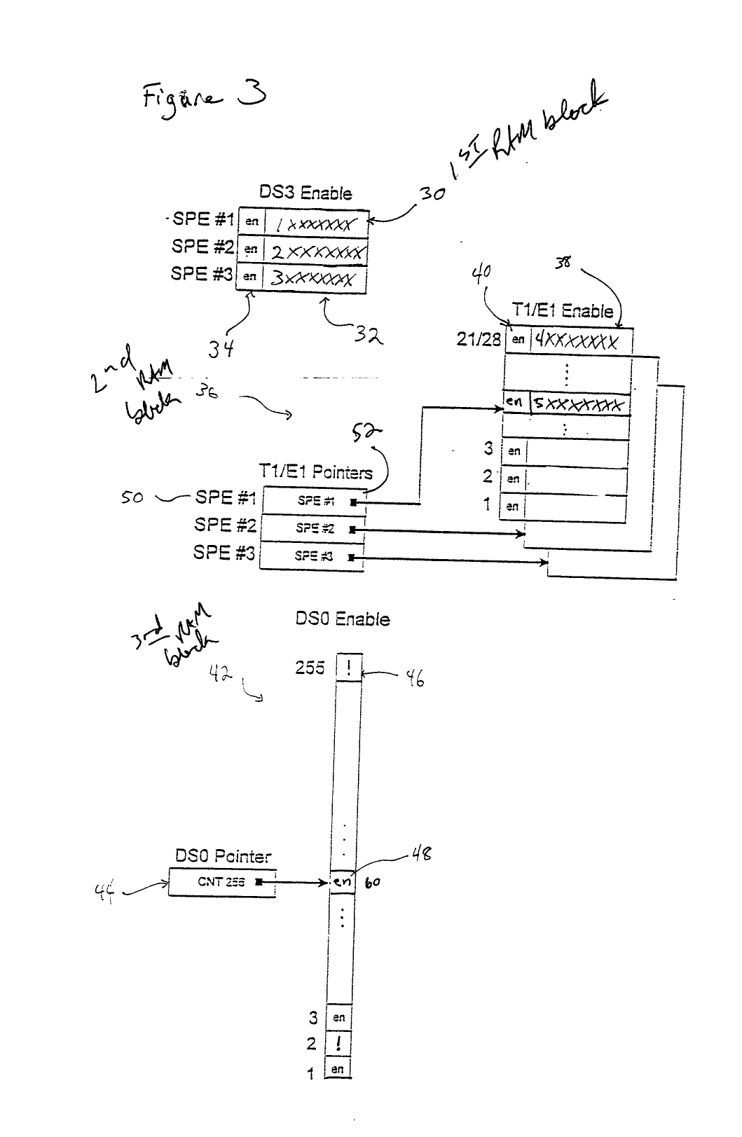

The example of FIG. 3 is provided in order to assist in understanding the invention. An implementation of the polling regime of the invention according to the states shown and described with reference to FIG. 2 is illustrated. The polling manager (10, FIG. 1) includes polling logic and employs three Random Access Memory (RAM) blocks and a state machine to control the polling frequency for all channels of the communications network. It will be understood that the physical implementation of the memory or logic elements are not crucial to the concept of the of the invention. Preferably, a first RAM block, DS3 RAM 30, is a 3×9 block (3 entries, 9 bits each). The lower eight bits 32 are used to store channel identifications for each of the DS3 channels. The most significant bit 34 is used to indicate whether each channel is enabled, in other words, in readiness to send data. The second RAM block, the E1/T1 RAM 36, is preferably provided with three 31×9 blocks configured as one 96×9 memory. It will be apparent to those skilled in the arts that in the case of E1, addresses 22-28 are not used, since each address corresponds to a slot within the SPE. Similar to the DS3 RAM 30, the lower eight bits 38 of the E1/T1 RAM 36 contains the channel identifications, and the most significant bit 40 indicates whether each channel is enabled. The third RAM block, DS0 RAM 42, is a 256×1 block. Its address 44 is used to select the channel identification 46 of a DS0 channel. The content 48 of each channel identification indicates whether the corresponding DS0 channel is enabled. A four-cycle state machine (FIG. 2) is used to manage the polling. The four cycles are split into three cycles to service each of the Synchronous Payload Envelopes (SPEs), and a fourth cycle dedicated to servicing DS0 data.

With further reference primarily to FIG. 3, an example of managing the interleaving of data from a plurality of channels having a plurality of data rates into a single interface is described. Beginning arbitrarily with the Service SPE1 state, the SPE1 components of the RAM blocks 30, 36, 42 are simultaneously polled for enabled channels. When the DS3 RAM 30 is checked in this example, an enabled DS3 channel is identified, channel 1xxxxxxx, as shown. Accordingly, the data from the identified enabled DS3 channel 1xxxxxxx is transmitted to the egress port. The next state is then reached, the Service SPE2 state.

Returning to the Service SPE1 state of the above example, it should be understood that when the SPE1 components of the RAM blocks are simultaneously polled for enabled channels, a check of the DS3 RAM 30 may reveal that there is no enabled DS3 channel in a particular instance. Then, the Service SPE1 state falls through to the SPE1 T1/E1 pointers of the T1/E1 RAM 36. The SPE1 component 50 of the T1/E1 RAM 36 in this example contains a T1/E1 Pointer 52, which points to an enabled T1/E1 channel 5xxxxxxx. The enabled T1/E1 channel 5xxxxxxx is then permitted to send data through the egress port, completing the Service SPE1 state. The next state is then reached, the Service SPE2 state.

Similarly, returning to the Service SPE1 state in another alternative example, if neither an SPE1 DS3 channel nor an SPE1 E1/T1 channel is enabled, the Service SPE1 state falls through to the DS0 RAM 42 in order to identify a DS0 Pointer 44 to an enabled DS0 channel, in this instance identified as channel 60. The DS0 pointer 44 indicates that the currently-pointed-to DS0 channel (address 1-255) is enabled. The enabled DS0 channel 60 is then invited to transmit its DS0 data through the egress port.

Thus, the interleaving management functions of the invention identify enabled channels according to a predetermined data rate hierarchy. Channels corresponding to the data rates being serviced are simultaneously checked for readiness to send data. In the present example, the DS3, T1/E1, DS0 hierarchy is serviced in SPE1, SPE2, and SPE3 states. A separate DS0 state is preferably also provided in order to ensure that DS0 data is timely transmitted. In this way the state machine interleaves data for sending on every clock cycle. It should be understood that the invention does not rely upon preconfigured channels. In the event an operator using the invention takes one or more channels off-line, places more channels on-line, or changes the data rates of channels, the interleaving management functions of the invention require no reconfiguration. For example, again referring to FIG. 3, if an operator were to disable channel 1XXXXXXX, or enable channel 3XXXXXXX, or swap channel 5XXXXXXX, the methods and systems of the invention would continue to interleave data without alteration. The only changes would be to the enable bits indicating readiness to send data or to the locations of the channel identifiers.

From reference to the above, it is contemplated that one skilled in the art would be able to reduce to practice the methods and systems of the present invention. Table 1 below provides representative pseudo code showing an example of the method of the invention. Those skilled in the art will recognize that the examples shown and discussed are alternatively represented in Table 1 and that various formats of machine-readable instructions and hardware may be used to implement the invention.

As can be seen with reference to the pseudo-code of Table 1, the DS0 counter is set to zero, and an array of T1/E1 counters is set up starting at t=0. For t±3, the timer is incremented. The mechanism then checks for DS3 data and polls DS3 channels if appropriate. The mechanism also checks for T1/E1 data and polls T1/E1 channels if appropriate. The mechanism also checks for DS0 enabled channels and polls DS0 channels as appropriate. The array elements are then incremented and the DS0 counter is also incremented. It will be clear to those skilled in the arts that Table 1 is a general representation of the concept of the invention and that the pseudo-code corresponds to the representation of invention of FIG. 3 and accompanying description, and is not intended to limit the invention to a particular coding structure or computer language.

TABLE 1
Polling algorithm pseudo-code

| | |
|---|---|
| ds0 = 0; | // ds0 channel counter |
| [2:0] tlel = 1; | // array of 3 tlel 1-28/1-31 counters |

while (1)
{

for (t = C ; t <= 3 ; t++ )
{

| | |
|---|---|
| If (t < 3) | // DS3/T1/E1 time slots |
| { | |

| read SPEx DS3 Polling Configuration RAM -> {t} , | |
|---|---|
| read SPEx T1/E1 Polling Configuration RAM -> {t} ; | |
| read DS0 Polling Configuration RAM -> {ds0} , | |
| read Transmit SPE T1/E1 Configuration Register {t} ; | |
| if (DS3 (EnBit] -> {t} == 1); | // DS3 enabled |

poll DS3(ChanId] -> {t} ;

| | |
|---|---|
| else if (T1/E1 [EnBit] -> {t*tlel[t]} == 1) | // T1/E1 enabled |
| { | |

| poll T1E1 {ChanId] -> {t*tlel[t]), | |
|---|---|
| tlel(t]- - ; | |
| if (tlel{t] > 31 ∥ | // E1 1-31 |

| | |
|---|---|
| (tlel(t] > 28 && T1/E1 reg(t] == 1)) | // T1 1-28 |

tlel(t] = 1 ,

| } | |
|---|---|
| else if (DSC->{ds0} == 1) | // DS0 enabled |
| { | |

poll DSC->(ds0} ;
ds0 = (ds0 == 255) ? 0 : ds0++ ,

| } | |
|---|---|
| else | // no DS0/T1/E1/DS3 |
| { | |

| tlel(t)++; | |
|---|---|
| if (tlel(t] > 31 ∥ | // E1 1-31 |

| | |
|---|---|
| (tlel(t] > 28 && T1/E1 reg[t] == 1)) | // T1 1-28 |

tlel (t] = 1 ,

ds0 = (ds0 == 255) ? 0 : ds0++ ,

}

| | |
|---|---|
| } | // end if t < 3 |

| | |
|---|---|
| if (t == 3) | // DS0 only time slot |

{

read DS0 Polling Configuration RAM -> {ds0} ;
poll DS0->{ds0} ;
ds0 = (ds0 == 255) ? 0 : ds0++ ;

| | } |
|---|---|
| } | // end for loop |

| | |
|---|---|
| } | // end while |

We claim:

1. In a data communications system, a method of interleaving data into a single interface from a plurality of channels supporting a plurality of data rates, the method comprising the steps of:
polling each channel in the data communications system to determine if the channels are active, the polling order determined according to a state machine, the state machine comprising at least one state for each data rate supported by the plurality of channels; and
interleaving data from the active channels into the single interface according the states of the state machine.

2. The method of claim 1 further comprising the step of changing the data rate of at least one of the plurality of channels.

3. The method of claim 1 wherein the state machine further comprises at least four states.

4. The method of claim 1 further comprising the step of buffering the data.

5. The method of claim 1 further comprising the step of enabling one or more channels.

6. The method of claim 1 further comprising the step of disabling one or more channels.

7. The method of claim 1 wherein the data channels comprise dissimilar physical layers.

8. The method of claim 1 wherein the data communications network comprises a synchronous optical network (SONET).

9. The method of claim 1 wherein the plurality of data rates comprise digital signal level zero (DS0), digital signal level one (DS1), digital signal level two (DS2), and digital signal level three (DS3).

10. For use in a data communications network, a reconfigurable transmit mechanism supporting the interleaving of data from data channels having dissimilar data rates, comprising:
sequential circuit means for polling each data channel to identify active data channels; and
means for interleaving data from the active data channels into a single interface for transmission in the data communications network.

11. The mechanism of claim 10 further comprising means for reconfiguring the data channels for different data rates.

12. The mechanism of claim 10 further comprising means for buffering the data prior to interleaving.

13. The mechanism of claim 10 wherein the data communications network further comprises a SONET.

14. The mechanism of claim 10 further comprising means for enabling/disabling channels.

15. A data communications routing circuit supporting the interleaving of data from a plurality of data channels having dissimilar data rates, comprising means for:
(a) identifying one or more first active data channels from among a plurality of channels of a first data rate;
(b) inviting the one or more first active channels to send data at a first data rate;
(c) identifying one or more next active data channels from among a plurality of channels of a next data rate; and
(d) inviting the one or more next active channels to send data at a next rate.

16. The routing circuit according to claim 15 further adapted for the reiteration of steps (c) and (d) for at least three dissimilar data rates.

17. The routing circuit according to claim 15 further adapted for the reiteration of steps (c) and (d) for five or more dissimilar data rates.

18. The routing circuit of claim 15 further comprising means for reconfiguring channels for different data rates.

19. The routing circuit of claim 15 wherein the data communications network further comprises a SONET.

20. The routing circuit of claim 15 further adapted for dynamically activating/deactivating one or more channels.
